(19) United States
(12) Patent Application Publication
(10) Pub. No.: US 2026/0350009 A1
(43) Pub. Date: Nov. 5, 2026

(54) COLLECTING SQL STATISTICS AND MANAGING SQL QUERIES

(71) Applicant: Microsoft Technology Licensing, LLC, Redmond, WA (US)

(72) Inventors: Smita BEHERA, Bellevue, WA (US); Manish Eknath TAWADE, Redmond, WA (US); Irving Alfonso COVARRUBIAS MARTIN DEL CAMPO, Bellevue, WA (US); Umachandar JAYACHANDRAN, Sammamish, WA (US); Gautham MUTHYALA, Hyderabad (IN)

(21) Appl. No.: 19/195,053

(22) Filed: Apr. 30, 2025

(51) Int. Cl. G06F 16/2455; G06F 9/50; G06F 9/54

(52) U.S. Cl. CPC G06F 16/2455; G06F 9/5038; G06F 9/547

(57) ABSTRACT

The present disclosure relates to systems, methods, and computer-readable media for gathering statistics related to execution of SQL queries by an SQL server in a manner that allows for real-time collection and quickly responding to different scenarios based on the information contained in the received statistics. The examples described herein involve generating a batch request that is provided in-line with an SQL query batch in which the batch request includes instructions that enable an SQL server to generate and return a return set that provides accurate and precise data about execution of the SQL query batch in a way that allows the systems described herein to take quick and strategic action to fix any potential conditions that are negatively affecting execution of the SQL query batch.

### BACKGROUND

Recent years have seen a rise in the use of Structured Query Language (SQL) services and resources being used in processing or otherwise executing queries, often serving as a backbone for data management and retrieval in a variety of applications. These SQL servers will often handle a vast array of operations, from simple data requests to complex transactions involving tables and databases. This SQL framework provides an efficient manner to process large volumes of queries, and even provides mechanisms to track data associated with consumption of server resources on the SQL servers.

While conventional SQL systems provide an efficient manner to process a variety of data management and retrieval operations, SQL systems suffer from a number of limitations and drawbacks. For example, while SQL servers provide a mechanism for generating and retrieving logfiles that include statistics and other usage information associated with executing SQL queries, conventional approaches for collecting these statistics often results in usage statistics that are difficult to parse or associate with specific portions of queries and/or specific statements of the queries. Indeed, due to protocols and formats with which queries are submitted and processed, as well as the manner in which statistics are gathered and reported by the SQL server, it is quite difficult and often impractical to draw conclusions about usage statistics without a robust offline analysis engine.

These and other difficulties exist in connection with collecting and analyzing usage statistics associated with executing SQL queries on SQL server resources.

### BRIEF DESCRIPTION OF THE DRAWINGS

FIG. 1 illustrates an example environment including an SQL statistics management system for collecting and taking action with respect to processing SQL queries in accordance with one or more embodiments.

FIG. 2 illustrates an example workflow showing an implementation of the SQL statistics management system in accordance with one or more embodiments.

FIG. 3 illustrates an example batch request and resource statistics associated with executing an SQL query batch in accordance with one or more embodiments.

FIG. 4 illustrates an example implementation of a throttling service used in connection with the SQL statistics management system in accordance with one or more embodiments.

FIG. 5 illustrates an example series of acts for managing collection of batch statistics related to executing one or more SQL queries in accordance with one or more embodiments.

FIG. 6 illustrates certain components that may be included within a computer system.

### DETAILED DESCRIPTION

The present disclosure is related to methods, systems, and computer-readable media for managing collection of batch statistics including resource data associated with executing any number of SQL queries using an SQL server in a manner which allows real-time analysis of the SQL statistics. As will be discussed in further detail below, an SQL statistics management system may be used by a service that interacts with an SQL server to request SQL statistics in-line with SQL queries that are submitted or otherwise provided to the SQL server for processing. This batch request provides an SQL server instructions that enable the SQL server to provide a result set in conjunction with result(s) of a received query or batch of queries. This real-time delivery of the result set together with query results enables the SQL statistics management system to quickly analyze SQL statistics and perform any of a variety of mitigation actions, as necessary, in response to patterns or data contained within the SQL statistics provided by the SQL server.

As an illustrative example, and as will be discussed in further detail below, a SQL statistics management system may initiate a batch request including an in-line request of an SQL query batch that identifies one or more statistics (e.g., types of statistics) for an SQL server to collect and return in conjunction to a query response(s). The SQL statistics management system may receive a result set associated with a given SQL query batch that includes a variety of statistics (e.g., batch-level statistics, statement-level statistics) based on information contained within the batch request. Once received, the SQL statistics management system may evaluate the SQL statistics and determine whether a trigger condition exists with respect to executing the SQL queries (e.g., spikes in resource usage, latency with respect to certain statements or APIs, excessive requests). The SQL statistics management system may further perform any of a variety of mitigation actions based on the observed trigger condition and/or based on the analysis of the SQL statistics received form the SQL server.

The present disclosure includes a number of practical applications that provide benefits and/or solve problems associated with collecting and analyzing SQL statistics from an SQL server. Some non-limiting examples of these applications and benefits are discussed in further detail below.

For example, by providing a mechanism whereby a customer (e.g., a client, server, service, or other entity communicating with an SQL server) can identify one or more SQL statistics to collect and return as part of a query or batch of queries, the SQL statistics management system provides flexibility as to which statistics can be collected in conjunction with processing an SQL query batch. Indeed, as will be discussed in further detail below, a batch request may include any number of statistics identifiers indicating any variety of statistics that should be returned as part of a result set. This provides a powerful tool in expanding or focusing functionality of the SQL statistics management system with respect to analyzing SQL statistics and acting based on the analysis of the various types of SQL statistics.

In addition to providing flexibility in collecting a wide variety of statistics, the SQL statistics management system additionally provides scalability with respect to new or different types of statistics that become available. For example, as the features and capabilities of SQL servers continue to expand, providing a framework that enables a customer to identify types of statistics enables the customer to identify any specific type of statistic that the SQL server is capable of tracking and logging. In this way, the SQL statistics management system becomes more capable as the capabilities of the SQL server also expand.

In addition, by including a batch request in-line with an SQL query (or set of queries), the SQL statistics management system enables real-time collection of SQL statistics as the SQL query(s) are processed. Where conventional systems will often require SQL statistics to be stored and analyzed offline, this in-line request and result set that is provided based on the in-line request enables the SQL statistics management system to analyze statistics as they are received from the SQL server. This is in part due to the awareness of the SQL statistics management system of the correlation between the received statistics and the SQL query(s) that was submitted with the in-line batch request. This awareness of the correlation between the specific SQL query batch (and respective statements that make up the batch) and the statistics that are collected in real-time enables the SQL statistics management system to more quickly and efficiently analyze SQL statistics in a manner much improved over conventional offline analysis techniques in which statistics are often received in batches and the correlation between respective metrics and queries are not immediately known.

In addition to the general benefit of receiving SQL statistics sooner than in conventional delayed reporting, by including the batch request in-line with the SQL queries, the SQL statistics management system additionally is able to quickly determine which APIs and which stored procedures (SPROCs) are associated with the received SQL statistics. Indeed, by including the batch request in-line, the SQL statistics management system is able to have immediate awareness of which statistics are corelated with specific APIs. This awareness is particularly beneficial where different APIs will often call common SPROCs or other sets of SQL statements, and where conventional approaches to collecting statistics will not yield to an easy or convenient differentiation between which SPROCs or statements are called by respective APIs. In this manner, the SQL statistics management system is able to quickly identify which APIs and associated statements are causing certain anomalies or trends in the SQL statistics, thus enabling the SQL statistics management system or other service to perform actions that will address potential issues on the SQL server and/or with certain clients.

The methods and systems described herein additionally provide benefits over conventional ad-hoc approaches to collecting and analyzing SQL statistics. For instance, by providing the batch request in-line with respect to a batch of statements or SQL query(s), the SQL statistics management system enables aggregation of statistics at a batch level rather than exclusively at an individual statement level. This also enables the real-time request of all SQL statistics for a given batch of queries without adding request statements for each individual statement.

As illustrated in the foregoing discussion, the present disclosure utilizes a variety of terms to describe features and advantages of the systems described herein. Additional detail is now provided regarding the meaning of some example terms.

For example, as used herein, a “cloud computing system” refers to a network of connected devices that provide various services to clients (e.g., cloud clients, client devices, network devices). A cloud computing system may refer more generally to a distributed computing network (or system) that includes a collection of physical computing devices (e.g., server nodes) organized in a hierarchical structure. This hierarchical structure may include regions, zones, clusters, racks, or other groupings of server nodes (e.g., virtual local area networks, fault domains). While one or more embodiments described herein refer specifically to detecting and mitigating regressions on a cloud computing system, features described herein with respect to detecting and mitigating regressions may apply more generally to other distributed computing network or to individual computing devices. The cloud computing system may refer to a private or public cloud computing system.

As used herein, a “statistic” or “SQL statistic” may refer to a metric or cost associated with utilization of a computational resource of a computing device or computing system. Specifically, in one or more embodiments described herein a statistic refers to a metric associated with resource utilization by an SQL server. In one or more embodiments described herein, a statistic(s) is referred to as a “batch statistic” “SQL statistic” “resource statistic” or simply “statistic” to refer to various types of statistics associated with execution of statements and/or queries by an SQL server.

Statistics may have varying levels of granularity, referring to statistics over discrete periods of time, statistics with respect to individual statements or queries, and/or cumulative statistics over larger periods of time and/or with respect to batches of multiple statements or multiple queries. Non-limiting examples of SQL statistics may include time or duration statistics (e.g., execution time, CPU time), quantity statistics (e.g., number of reads/writes, logical read/writes, physical read/writes, requests), resource usage statistics (e.g., memory usage, CPU usage), latency statistics (e.g., various types of waits), and any other type of statistics that an SQL server is configured to log or otherwise track.

As used herein, a “batch” “SQL batch” or “SQL query batch” refers to a structured command or batch of commands used to interact with a relational database management system (e.g., an SQL server or service) to perform any number of commands, such as retrieving, inserting, updating, or deleting data stored within a database in accordance with instructions contained within the structured command(s). In one or more embodiments, the batch refers to an SQL batch in which the commands are written in an SQL language.

As used herein, a “batch request” refers to a request that is made in conjunction with an SQL query batch to retrieve SQL statistics associated with execution of one or more SQL queries. The batch request may refer to an in-line request in which instructions indicating specific types of statistics are included within the SQL query batch are provided in-line with the query(s) such than an SQL server is instructed to leverage log functions of the SQL server to gather specific statistics to include as part of a result set in conjunction with executing and delivering a response to a given query(s).

In one or more examples described herein, a batch query or SQL query may call an SPROC as part of executing the query(s). As used herein, an SPROC refer to a precompiled set of statements (SQL statements) that are processed as a unit by an SQL server. SPROCs may refer to established sets of commands that have been developed and configured to perform specific tasks, and provide a useful tool to process more complex commands without repeatedly compiling SQL statements or potentially risking security of a database. SPROCs described herein are not intended to be limiting to any particular customer or platform, but may be applicable to any set of statements that may be processed as a unit by an SQL server (or other relational database management system).

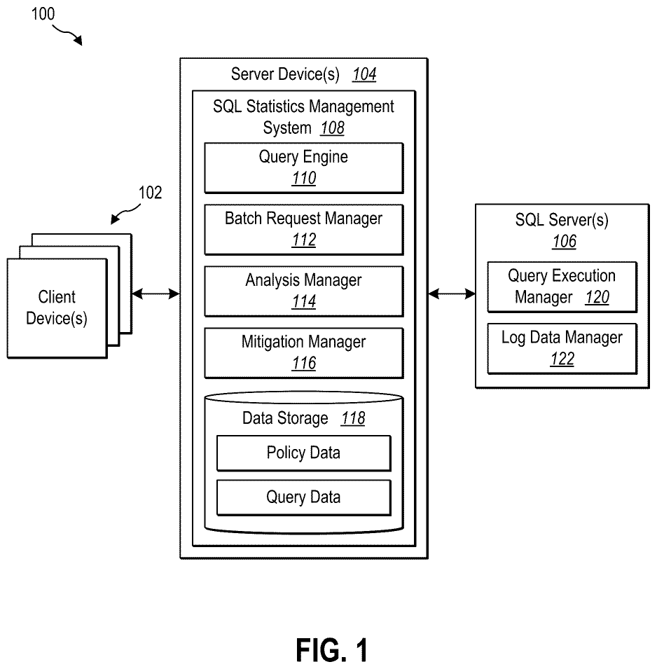

Additional detail will now be provided regarding systems described herein in relation to illustrative figures portraying example implementations. For example, FIG. 1 illustrates an example environment 100, which may refer to a network of computing devices or a cloud computing system. As shown in FIG. 1, the environment 100 includes a plurality of client devices 102, one or more server device(s) 104, and one or more SQL server(s) 106. As shown in FIG. 1, the server device(s) 104 has an SQL statistics management system 108 implemented thereon, the features of which will be discussed in further detail below.

It will be appreciated that this framework of devices 102-106 is provided by way of example in connection with at least one embodiment and is not intended to be limiting to all embodiments. For example, where the client devices 102 and server device(s) 104 are shown as separate devices, other embodiments may include a single set of devices that communicate directly with the SQL server(s) 106 (e.g., rather than the client devices 102 communicating through the server device(s) 104, as shown in FIG. 1.

In this example, the server device(s) 104 is associated with a customer having an account or pre-established relationship with the SQL server(s) 106, and which provides various customer services to a client base associated with the client devices 102. For instance, the customer associated with the server device(s) 104 may include a document management or any client-facing system that provides a service to the client devices 102 and which leverages the functionality of the SQL server(s) 106 in providing said services to the client device 102. Thus, in one or more embodiments described herein, a “customer” refers to an administrator or owner of the server device(s) 104 while a “client” or “user” refers to an individual or organizations associated with the respective client device(s) 102. For instance, in one or more embodiments described herein, the server device(s) 104 may generate or relay SQL queries based on requests or other inputs provided by the client devices 102. In this manner, the SQL statistics management system 108 may have awareness of the relationship between received client requests and the specific SQL query statements that are generated and provided to the SQL server(s) 106.

As just mentioned, and as shown in FIG. 1, the environment 100 includes any number of computing devices, including the client devices 102, server device(s) 104, and SQL server(s) 106. These respective devices may refer to various typers of computing devices including, by way of example, mobile devices, desktop computers, server devices, Internet of Things (IOT) devices, edge network devices, or any other type of computing device capable of performing the features and functionalities described herein.

In one or more embodiments, the client devices 102 may refer to mobile or non-mobile personal devices or endpoints that communicate with server device(s) 104 and SQL server(s) 106, which include more robust server devices at remote locations from the client devices 102. These devices 102-106 may communicate with one another over a network or multiple networks using any of a variety of communication platforms or technologies. Indeed, in one or more embodiments, the server device(s) 104 and SQL server(s) 106 refer to devices that are hosted on a cloud computing system. In one or more embodiments, the server device(s) 104 is on a first cloud computing system while the SQL server(s) 106 is on a separate network or separate computing system.

Additional detail in connection with the SQL statistics management system 108 will now be discussed below. Features described below in connection with respective components of the SQL statistics management system 108 may be applied to single or multiple device systems. For example, one or more of the query engine 110, batch request manager 112, analysis manager 114, or the mitigation manager 116 may be implemented on different server device(s). Thus, while one or more embodiments described herein refer to an SQL statistics management system 108 implemented on a single server device, it will be appreciated that features of the respective components may be implemented across multiple devices.

As noted above, the SQL statistics management system 108 includes a query engine 110. In one or more embodiments described herein, the query engine 110 handles requests that arrive from the client devices 102. In receiving the queries, the query engine 110 can maintain data associated with clients and log or otherwise track a record of the requests as they arrive from the client device 102.

In addition to receiving and managing collection of requests from the client devices 102, the query engine 110 may generate SQL queries based on the received inputs and requests from the client devices 102. For example, based on a user input or request received from a given client, the query engine 110 may generate a batch or set of statements in an SQL format that can be processed by the SQL server 106. In one or more embodiments, the query engine 110 draws from a database or cache of APIs and SPROCs in generating the SQL batch.

As further shown in FIG. 1, the SQL statistics management system 108 includes a batch request manager 112 that assists that query engine 110 in generating a batch request to provide to the SQL server 106 in conjunction with the SQL query(s) (e.g., batch of SQL statements based on the user request(s)). In one or more embodiments, the batch request manager 112 generates the batch request by preparing or otherwise obtaining instructions to include in-line with the SQL batch.

In one or more embodiments, the batch request manager 112 provides specific instructions indicating what should be included in the result set. For example, the batch request manager 112 may augment or otherwise modify an SQL batch or a request from a client by adding instructions, in-line with the SQL batch, indicating one or more types of statistics that should be included within a result set. Consistent with examples described above, the batch request manager 112 may add instructions associated with returning any of a variety of statistics, including any defined statistic that the SQL server 106 is configured to log, report, or otherwise collect. These various types of statistics may be identified using any identifier that the SQL server 106 is equipped to recognize.

In addition to generally indicating types of statistics to collect, the batch request manager 112 may further indicate a granularity of the statistics. For example, in one or more embodiments, the batch request manager 112 adds granularity instructions indicating whether a result set should include a report of overall statistics (e.g., statistics across multiple query statements) as well as a report of individual statistics for specific statements. Other examples include instructions for collecting statistics as an SPROC level, API level, or other granularity that the SQL server 106 is capable of tracking, and which may be included within a result set that is returned to a customer (e.g., to the server device(s) 104).

While this disclosure is not intended to limit the types of statistics or granularity of the statistic that are collected and included within a given result set, many examples of statistics and granularities are provided herein. By way of example, in one or more embodiments, the statistics include resource usage statistics. Examples of these resource usage statistics may include CPU usage, memory usage, storage usage, etc. As used herein, resource usage statistics may refer to measurements that relate to usage of computing, memory, storage, I/O, bandwidth, or any other resource that hardware or virtual devices the SQL server(s) 106 provide.

As another example, in one or more embodiments, the statistics include one or more latency statistics. Examples of latency metrics may include wait times, stops, or other metric that affects a duration of time in which execution of statements or queries are processed by the SQL server(s) 106. Indeed, as used herein, a latency statistic may refer to any measurement or metric that relates to time that it takes to execute a statement, query, or any operation (or set of operations) using the hardware and/or virtual devices on the SQL server(s) 106.

As another example, in one or more embodiments, the statistics include one or more quantity statistics. Examples of quantity metrics include number or frequency of operations, requests, or execution of individual tasks in executing statements or queries by the SQL server(s) 106. Indeed, as used herein, a quantity statistic may refer to any metric or measurement that relates to a quantity or frequency of actions that are performed by any resource on the SQL server(s) 106 in processing a given task or statement or query.

As noted above, the batch request manager 112 adds the instructions indicating types of statistics, granularity of statistics and other instructions in-line with the SQL batch. This in-line insertion of instructions for gathering and returning statistics realizes a number of benefits in obtaining SQL statistics from the SQL server based on execution of statements within the SQL batch. For example, by inserting the batch request in-line with the SQL batch, the SQL statistics management system 108 enables immediate evaluation of the SQL statistics that are returned at a same time as the query results are processed and returned to the customer. As opposed to conventional approaches in which the statistics data is stored for offline evaluation, this return of SQL statistics with the SQL query response enables the SQL statistics management system 108 to make real-time decisions based on observed trends or spikes indicative of abnormal behavior observed by the SQL server 106.

As shown in FIG. 1, the SQL statistics management system 108 includes an analysis manager 114. The analysis manager 114 may evaluate the statistics as they are received (e.g., within the result sets). In one or more embodiments, the analysis manager 114 is tasked with recognizing anomalies, spikes, abnormal trends, and other measurements or metrics that are included within the received result sets. In one or more embodiments, the analysis manager 114 analyzes the received statistics to determine whether a trigger condition associated with a threshold metric(s) applies to the statistics contained within a result set (or multiple result sets). Additional detail in connection with detecting trigger conditions based on an analysis of the SQL statistics will be discussed below.

As further shown in FIG. 1, the SQL statistics management system 108 further includes a mitigation manager 116. The mitigation manager 116 may perform any number of acts related to mitigating an observed problem or trigger condition that is detected based on the received statistics within one or more result sets. The mitigation manager 116 may perform a variety of mitigation actions. In one or more embodiments, the mitigation manager 116 causes the serve device(s) 104 (or other device) to implement a throttling action with respect to incoming or outgoing requests and communications. As an alternative, in one or more embodiments, the mitigation manager 116 may generate or cause an incident report to be generated with respect to the observed statistics. In one or more embodiments, the mitigation manager 116 provides a service that performs one or more of the mitigation actions described herein. In one or more embodiments, the mitigation manager 116 provides instructions or a command to a service or other device that performs and/or carries out different mitigation actions.

As shown in FIG. 1, the SQL statistics management system 108 includes a data storage 118, which may include a variety of different data stored thereon. For example, as shown in FIG. 1, the data storage 118 may include policy data indicating various rules or policies that one or more components of the SQL statistics management system 108 considers in determining whether a certain statistic can be collected, or whether a trigger condition is satisfied or has been violated. For example, and as will be discussed in further detail below, the policy data may include threshold, rules, and other information that the SQL statistics management system 108 considers in determining if a trigger condition indicating a threshold metric has been observed within one or across multiple result sets. Indeed, the policy data may include any data relied on by any of the components of the SQL statistics management system 108 in making one or more decisions or determinations described herein.

As further shown, the data storage 118 may include query data. The query data may include any information associated with queries that are generated and/or received by the SQL statistics management system 108. For example, the query data may include data associating APIs with SPROCs. Other examples may include query data that maps client requests with corresponding SQL queries that are generated based on those client requests. The query data may indicate identifiers of devices or account numbers associated with the various batch requests, ultimately providing information that enables the different components of the SQL statistics management system 108 to make decisions and perform various actions based on the query data.

As noted above, the environment 100 includes an SQL server 106, which may include a query execution manager 120 and a log data manager 122. The query execution manager 120 may receive SQL batches from the server device(s) 104 and execute any number of statements that make up the SQL batch(es). The query execution manager 120 may execute the received queries in any number of ways, using any combination of operations in accordance with a configuration of the query execution manager 120. Indeed, this includes any optimizations or joins or reordering of statements in performing a given batch query.

In addition to executing SQL statements of received batches, the SQL server 106 may further perform various tracking tasks associated with execution of the statements. For example, as shown in FIG. 1, the log data manager 122 may track any number of statistics associated with execution of the SQL statements. In one or more embodiments, the log data manager 122 tracks as many statistics as it is configured to track in accordance with instructions maintained on the SQL server 106 and independent of the instructions received from the server device(s) 104. Thus, when responding to instructions to collect certain statistics in a batch request, the log data manager 122 may simply return statistics that the log data manager 122 is already collecting and logging, providing minimal overhead to operations of the SQL server 106.

Alternatively, in one or more embodiments, the log data manager 122 selectively tracks and logs certain statistics based on the instructions from the batch request included in-line with the SQL query batch. For example, in one or more embodiments, the log data manager 122 logs or tracks certain statistics for every SQL statement that is executed. In one or more embodiments, the log data manager 122 extends tracking to additional types of statistics as instructions by the batch request. In this manner, the log data manager 122 utilizes built-in functionality of the SQL server(s) 106 while preserving computing resources dedicated to tracking and logging various statistics, and selectively gathering and returning those statistics indicated within a given batch request as an associated SQL batch is being processed.

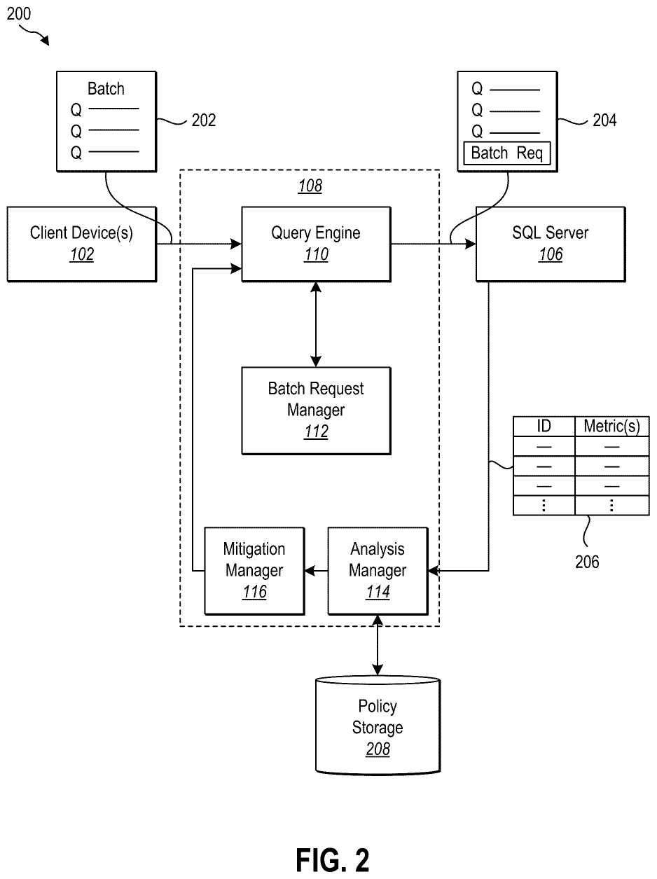

Additional detail will now be given in connection with an example workflow showing features and functionality of the SQL statistics management system 108 in accordance with one or more embodiments described herein. As shown in FIG. 2, the SQL statistics management system 108 may interact with client devices 102 and an SQL server 106 similar to the example described above in connection with FIG. 1.

As shown in FIG. 2, one or more client devices 102 may provide a query batch 202 to the query engine 110 of the SQL statistics management system 108. As shown in FIG. 2, the query batch 202 may include a listing, sequence, or set of statements that are provided as an object to the query engine 110. In one or more embodiments, the received query batch 202 has been already formatted in an SQL protocol capable of being executed by the SQL server 106. This may be a function or feature of an application on the client device 102 and/or the service that the client device 102 is interacting with, such as a cloud service or application that is hosted by a customer server (e.g., the server device(s) 104 or service in communication with the server device(s) 104).

Alternatively, in one or more embodiments, the query engine 110 formats a received client request into an SQL query batch such that the statements received by the query engine 110 may be processed or otherwise executed by the SQL server 106. In short, the query engine 110 may receive a query batch 202 ready for execution or modify received client requests to generate a query batch 202 to be executed by the SQL server 106.

As shown in FIG. 2, the query engine 110 may interact with the batch request manager 112 to facilitate inclusion of a batch request within the query batch 202. As discussed above, and as shown in FIG. 2, the batch request manager 112 may facilitate adding a batch request including instructions that are inserted in-line with the query batch such that the SQL server 106 receives an in-line batch query request 204 that includes both the query batch and the batch request included within a same object that is provided to the SQL server 106.

Upon receiving the in-line batch query request 204, the SQL server 106 may proceed to execute the SQL statements within the query batch while also tracking and logging the various statistics identified within the batch request. In one or more embodiments, the SQL server 106 generates a return set based on the batch request. The return set may include a variety of information and formatting.

By way of example, in one or more embodiments, the SQL server 106 generates a result set 206 including a table of statistical data that is collected and included within the result set 206 based on the various statistics identifiers included within the batch request. Alternatively, in one or more embodiments, the SQL server 106 generates a result set 206 including an informational message that is provided in conjunction with the query results (e.g., the results of executing the SQL query batch).

Each of the above approaches regarding the format of the result set 206 includes a number of benefits. For example, generating an informational message can be a low overhead way to provide the requested statistical data without modifying any features of the customer platform or the SQL server platform. This does not include any upgrades to existing infrastructure, and provides flexibility in how the informational message can be utilized. Alternatively, where the result set is provided as a table and as a separate object from the query results, the provides the benefit of standardization and easy interpretability of the results. In addition, the text of the result set does not need to parsed, and versioning between upgrades to the batch statistics can be handled in a convenient and easy manner. This approach further provides enhanced flexibility with the format of the result set, which allows for a variety of applications to be applied to the result set.

As shown in FIG. 2, the result set 206 is provided to the analysis manager 114 for further processing. As noted above, the analysis manager 114 may perform any number and variety of evaluations on the data contained within the result set 206 to determine whether a trigger condition exists with respect to executing the query batch. More specifically, the analysis manager 114 may evaluate the values from the result set 206 to determine whether a threshold metric observed in the statistics is present or whether there is a potential anomaly that should be addressed (or further analyzed).

In one or more embodiments, the analysis manager 114 considers any number of policies from a policy storage 208 in determining whether a given set of statistics from one or more result sets is representative of an anomaly or a problem that exists based on the statistics received from the SQL server 106. In one or more embodiments, the policy storage 208 includes a number of threshold metrics associated with different types of events or conditions. The analysis manager 114 may consider these threshold metrics in determining whether the received statistics are indicative of an anomaly or problem in execution of the SQL query batch.

The policy storage 208 may include policies associated with different types and combinations of statistics. By way of example, the policy storage 208 may include a set of CPU or memory usage metrics that represent an acceptable level of CPU or memory usage on the SQL server 106 to be used in executing a given set or number of query statements within a given query batch. If a received set of statistics exceeds the threshold memory or CPU usage, the analysis manager 114 may determine that a memory or CPU threshold condition exists and generate a signal to indicate (e.g., to the mitigation manager 116) that the trigger condition exists, and that mitigation action should take place to remedy the condition.

As another illustrative example, the policy storage 208 may include a set of latency metrics that represent an acceptable level of latency in executing the SQL server 106. For example, the policy storage 208 may include a threshold number or threshold percentage of waits or delays over a certain duration of time for a given SQL query batch that can be tracked before a threshold condition associated with latency is met. Similar to the above example, if the receive set of statistics indicates that a number of waits, delays, stops, or other time-related metrics exceed the threshold percent or number of timing metrics, the analysis manager 114 may determine that the latency condition exists, and that mitigation action should be taken.

In one or more embodiments, the policy storage 208 includes different metrics for different types of statistics. For example, the policy storage 208 may include a set of thresholds for a first type of statistic (e.g., resource-based metrics) and a different set of thresholds for a second type of statistics (e.g., latency-based metrics or quantity-based metrics). In some embodiments, the policy storage 208 includes different threshold metrics for combinations of different statistics (e.g., resource-based in combination with quantity based). In this manner, the analysis manager 114 may perform a more thorough and fine-tuned analysis that considers combinations of different types of statistics in determining whether a trigger condition applies (e.g., where both of two types of statistics exceed a threshold metric) or whether a certain condition does not apply (e.g., where only one of two types of statistics exceeds a threshold metric, but not necessarily both types of statistics exceed the threshold metric).

In addition to maintaining policies related to different types of statistics, the policy storage 208 may additionally include threshold metrics associated with certain SPROCs, APIs, specific groups of clients (e.g., geographic or account-based groupings of clients), and any other criteria that may be considered in determining whether a trigger condition exists that signals a potential anomaly or problem in the manner or details surrounding the execution of query batches by the SQL server 106. As noted above, one or more embodiments involve determining whether processing queries called by a certain API is problematic. As such, the policy storage 208 may include information that enables the analysis manager 114 to determine whether requests or queries that call a particular API are causing a trigger condition to be detected.

As shown in FIG. 2, after detecting a trigger condition, the analysis manager 114 may provide a detection condition signal to the mitigation manager 116 to perform further actions with respect to the detected trigger condition. As noted above, the mitigation manager 116 may perform a variety of actions to mitigate an abnormal or problematic condition associated with executing SQL statements by the SQL server 106.

For example, in one or more embodiments, the mitigation manager 116 may perform (or cause to be performed) a throttling action with respect to received requests and/or queries that are being submitted to the SQL server 106. For example, where the mitigation manager 116 receives a signal that a certain API is causing the trigger condition, the mitigation manager 116 may throttle client requests invoking the API to either allow for self-healing of workflows that are processing 100 s and 1000 s of SQL query batches or other positive impact on the throughput or resource usage of the SQL server 106. Indeed, in one or more embodiments, the mitigation managed causes the query engine 110 to throttle one or more subsequently received requests or SQL statements based on the trigger condition being detected.

As another example, the mitigation manager 116 may target specific clients that are associated with the trigger condition. For example, where the statistics or trigger condition indicates a particular account of users or geographic area of users, the mitigation manager 116 may throttle, block, or otherwise filter requests from the specific account or region until the circumstances surrounding the trigger condition can be fixed or further examined, while still allowing normal operation of requests with respect to other accounts or users that are not associated with the problems associated with the detected trigger condition(s).

As an alternative to throttling requests, the mitigation manager 116 may perform (or cause to be performed) any other of a variety of actions that address the trigger condition. For example, the mitigation manager 116 may cause an incident report to be generated, and provide the information necessary to further investigate the underlying cause of the problem. For example, where a certain SPROC or API is not operating correctly, the mitigation manager 116 may provide a report (e.g., an incident report) identifying the SPROC and/or API as well as relevant statistical information that has been collected to indicate what is happening with execution of statements that call the SPROC or API. This can be used by administrators or organizations to optimize deployment or maintenance of APIs, SPROCs, and other tools that are used in receiving and processing SQL queries.

In addition to other benefits discussed herein, one benefit of the above-workflow is that the SQL statistics management system 108 can perform each of the described actions while allowing the clients, customer, and SQL server 106 to continue normal operation with other queries and requests that are not necessarily associated with the detected trigger conditions. Indeed, by selectively throttling only those requests that are associated with or have APIs or SPROCs associated with the statistics that indicate anomalies or potential problems, the SQL statistics management system 108 allows for all other requests and queries to be processed and execute by the SQL server 106 to maintain normal operation of applications and services provided to the clients while simultaneously addressing the trigger condition(s) or providing the necessary tools to actors who are in a position to address or mitigate the trigger condition(s).

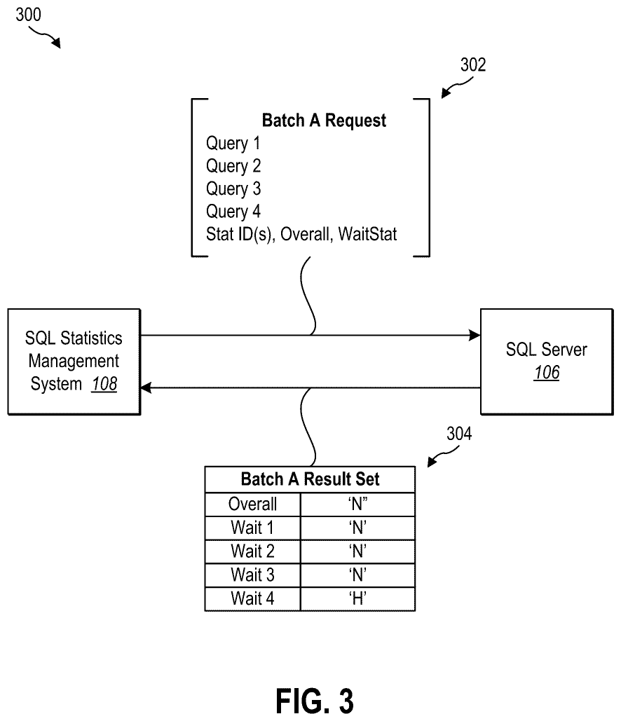

FIG. 3 illustrates an example interaction between the SQL statistics management system 108 and the SQL server 106 in accordance with one or more embodiments. More specifically, FIG. 3 illustrates an example workflow 300 in which a SQL statistics management system 108 generates an in-line batch request 302 embedded within a SQL query batch that may be provided to the SQL server 106 in conjunction with the SQL statements to be executed by the SQL server 106.

Consistent with one or more embodiments described herein, the batch request 302 may include identifiers of any number of query statements (e.g., Query1, Query2, Query3, Query4) and associated statistic identifiers that the SQL statistics management system 108 is requesting the SQL server 106 to collect and provide via a result set. For the sake of explanation, the batch request 302 includes a listing of four queries and an associated wait statistic identifier. Nevertheless, any number of query statements and statistics identifiers may be identified within the batch request.

In addition to identifying individual query statements, the batch request 302 may further include an identifier associated with the query batch as well as statistic identifier(s) for statistics to be reported in conjunction with the query batch (e.g., cumulative statistics). For example, as shown in FIG. 3, the batch request 302 includes an indication of a cumulative statistic to be included within a result set which, in this example, indicates a cumulative wait statistic to be included reflective of a cumulative wait metric for the entire batch of SQL statements.

As shown in FIG. 3, in response to the batch request 302, and in conjunction with executing the SQL statements of the query batch, the SQL server 106 may generate a result set 304. As shown in FIG. 3, the result set 304 may include a listing of statistics identifiers associated with respective query identifiers and values or metrics of the indicted statistics. The result set 304 may include any number of identifiers and associated metrics.

In the illustrated example, the result set 304 includes identifiers associated with certain queries or statements coupled with metrics or values of the respective query identifiers. In this example, the metrics are classifiers associated with wait times, specifically “N” indicating a normal range of wait times and “H” indicating a high or elevated (e.g., relative to a threshold) wait times. The result set 304 may include a combination of individual statistics values representative of metrics for the individual statements or queries, as well as cumulative statistics values representative of the metrics for the query batch (e.g., inclusive of multiple statements or queries).

While FIG. 3 illustrates an example showing individual statement identifiers, the result set 304 may include other identifiers and associated metrics. For example, in one or more embodiments, the result set 304 may include identifiers of SPROCs, which may refer to combinations of multiple statements that are commonly executed together, in combination of statistical values that have been requested via the batch request 302. Indeed, the result set 304 may include any number of statements, combinations of statements, as well as any number of associated statistics. As shown in the example, the result set 304 may include a table with any number of rows indicating identified statements or query identifiers (or SPROCs) as well as any number of columns including statistical values associated with the respective identifiers.

As noted above, the SQL statistics management system 108 can perform any number of mitigation actions based on trigger conditions that are detected within one or more received result sets. This evaluation and detection of trigger conditions may be based on individual result sets. Alternatively, in one or more embodiments, the SQL statistics management system 108 may evaluate and detect trigger conditions based on multiple received result sets, in which statistics are considered over periods of time that span the receipt of multiple result sets.

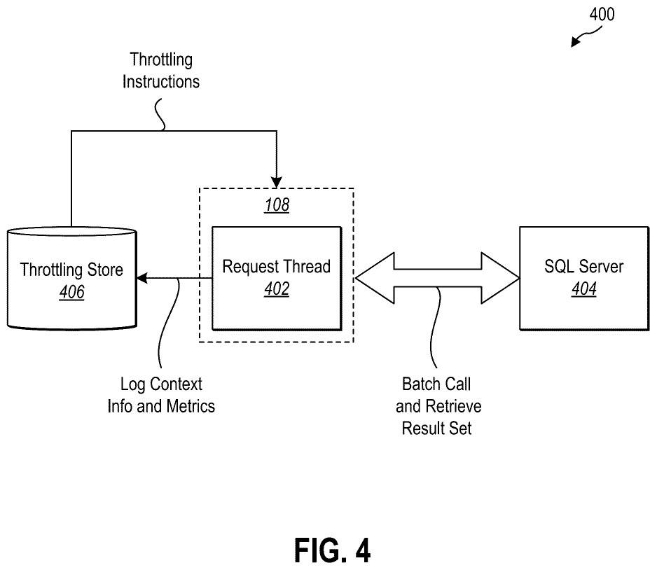

FIG. 4 illustrates one example implementation in which the SQL statistics management system 108 utilizes a throttling store and service to perform a mitigation action of throttling one or more requests that are received at the SQL statistics management system 108. In one or more embodiments, this throttling occurs on the same device as the SQL statistics management system 108 (e.g., as shown in FIG. 1). In one or more embodiments, the SQL statistics management system 108 uses a service or store that is not on the same device as the SQL statistics management system 108.

As shown in FIG. 4, the SQL statistics management system 108 may include a request thread 402 implemented thereon. This request thread 402 may represent client request that are concerted to SQL query batches. As shown in FIG. 4, the SQL query batch is provided in-line to an SQL server 404 as part of a batch call (e.g., an SQL query batch) in which the queries and in-line batch request(s) are provided to the SQL server 404.

The SQL server 404 may process the batch call and return a result set representative of the statistical data requested in-line within the batch call. The result set may be an informational message. The result set may alternatively be a table of identifiers and associated statistics, consistent with other examples described herein.

As shown in FIG. 4, the SQL statistics management system 108 may provide a signal or metric to the throttle store 406 to determine whether to apply a throttling action to incoming requests (e.g., client requests). In one or more embodiments, the SQL statistics management system 108 performs an analysis and provides an indication of any trigger conditions that exist with respect to the result set(s). Alternatively, in one or more embodiments, the SQL statistics management system 108 provides the result set (or information from the result set) to the throttle store 406, which performs the analysis, detects threshold conditions, and/or generates throttling instructions.

As shown in FIG. 4, the throttling store 406 provides the throttling instructions to the SQL statistics management system 108 for use in processing incoming requests. In particular, the SQL statistics management system 108 may begin throttling client requests that meet a certain criterion associated with the trigger condition that was identified in connection with the result set generated and provided by the SQL server 404.

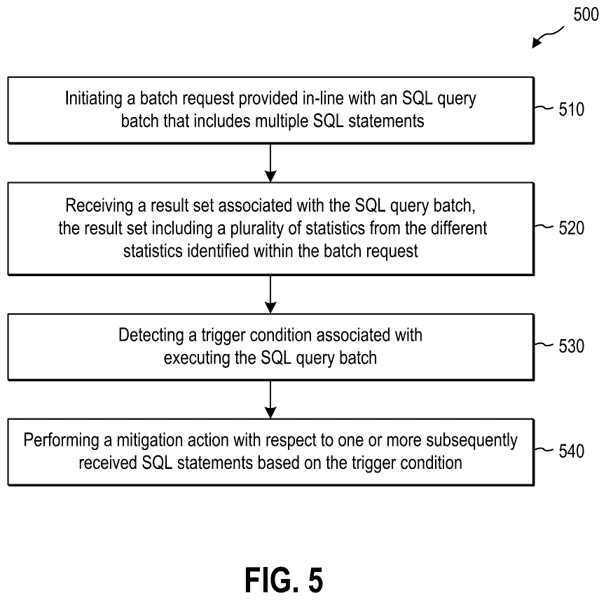

Turning now to FIG. 5, this figure illustrates an example flowchart including a series of acts for related to generating a batch request and obtaining batch statistics associated with processing a batch of SQL statements or queries. While FIG. 5 illustrates acts according to one or more embodiments, alternative embodiments may omit, add to, reorder, and/or modify any of the acts shown in FIG. 5. The acts of FIG. 5 can be performed as part of a method. Alternatively, a non-transitory computer-readable medium can include instructions that, when executed by one or more processors, cause a computing device (e.g., a server device) to perform the acts of FIG. 5. In still further embodiments, a system can perform the acts of FIG. 5.

As noted above, FIG. 5 illustrates a series of acts 500 related to generating a batch request and obtaining associated batch statistics. As shown in FIG. 5, the series of acts 500 includes an act 510 of initiating a batch request provided in-line with an SQL query batch that includes multiple SQL statements. In one or more embodiments, the act 510 involves initiating a batch request including an in-line request of an SQL query batch that includes multiple SQL statements, the batch request including identifiers of different statistics for an SQL server to collect in conjunction with execution of the SQL query batch on the SQL server.

As further shown in FIG. 5, the series of acts 500 includes an act 520 of receiving a result set associated with the SQL query batch, the result set including a plurality of statistics identified within the batch request. In one or more embodiments, the act 520 involves receiving a result set associated with the SQL query batch, the result set including a plurality of statistics from the different statistics identified within the batch request, wherein the result set includes at least one batch-level statistic indicating a cumulative statistic for the multiple SQL statements and one or more statement statistics indicating individual statistics for the multiple SQL statements.

As further shown in FIG. 5, the series of acts 500 includes an act 530 of detecting a trigger condition associated with executing the SQL query batch. In one or more embodiments, the act 530 involves detecting, from the result set, a trigger condition associated with executing the SQL query batch, the trigger condition indicating a threshold metric observed in the statistics contained within the result set.

As further shown in FIG. 5, the series of acts 500 include an act 540 of performing a mitigation action with respect to one or more subsequently received SQL statements based on the trigger condition. In one or more embodiments, the act 540 involves performing a mitigation action with respect to one or more subsequently received SQL statements based on the detected trigger condition from the result set for the SQL query batch.

In one or more embodiments, the result set includes a result table including statistics associated with statements of the SQL query batch that are received in conjunction with execution of the SQL query batch based on the batch request being an in-line request. In one or more embodiments, the result set includes an information message received from the SQL server in conjunction with a query response based on the batch request being an in-line request.

In one or more embodiments, the plurality of statistics includes one or more resource usage metrics associated with executing statements of the SQL query batch. In one or more embodiments, the plurality of statistics includes one or more latency metrics associated with executing statements of the SQL query batch. In one or more embodiments, the plurality of statistics includes one or more operation quantity metrics associated with executing statements of the SQL query batch. In one or more embodiments, the plurality of statistics includes statistics associated with one or more application programming interfaces (APIs) called when executing statements of the SQL query batch. In one or more embodiments, the plurality of statistics further includes statistics associated with stored procedures (SPROCs) that are called by each API of the one or more APIs when executing statements of the SQL query batch.

In one or more embodiments, the series of acts 500 includes an act of associating one or more application programming interfaces (APIs) with one or more stored procedures (SPROCs) called by the APIs when executing statements of the SQL query batch. In one or more embodiments, the trigger condition includes a threshold metric with respect to statistics from the plurality of statistics associated with an SPROC called by an API of the one or more APIs. In one or more embodiments, the mitigation action includes throttling requests associated with the associated API based on the statistics associated with the SPROC exceeding the threshold metric. In one or more embodiments, performing the mitigation action includes throttling requests received from clients associated with the trigger condition.

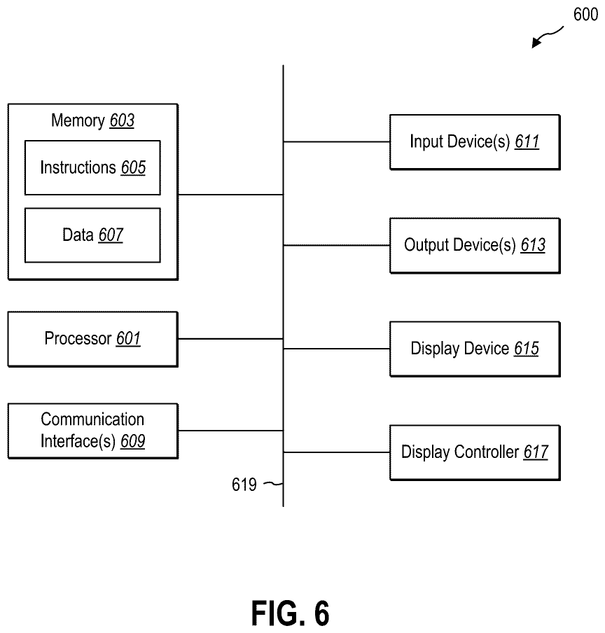

FIG. 6 illustrates certain components that may be included within a computer system 600. One or more computer systems 600 may be used to implement the various devices, components, and systems described herein.

The computer system 600 includes a processor 601. The processor 601 may be a general-purpose single-or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

As used herein, non-transitory computer-readable storage media (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method for managing batch statistics for structured query language (SQL) queries executed using an SQL server, the method comprising:
initiating a batch request including an in-line request of an SQL query batch that includes multiple SQL statements, the batch request including identifiers of different statistics for an SQL server to collect in conjunction with execution of the SQL query batch on the SQL server;
receiving a result set associated with the SQL query batch, the result set including a plurality of statistics from the different statistics identified within the batch request, the plurality of statistics being associated with statements of the SQL query batch that are received in conjunction with execution of the SQL query batch based on the batch request being an in-line request;
detecting, from the result set, a trigger condition associated with executing the SQL query batch, the trigger condition indicating a threshold metric observed in the plurality of statistics contained within the result set; and
performing a mitigation action with respect to one or more subsequently received SQL statements based on the detected trigger condition from the result set for the SQL query batch.

2. (canceled)

3. The method of claim 1, wherein the result set includes an information message received from the SQL server in conjunction with a query response based on the batch request being an in-line request.

4. The method of claim 1, wherein the plurality of statistics includes one or more resource usage metrics associated with executing statements of the SQL query batch.

5. The method of claim 1, wherein the plurality of statistics includes one or more latency metrics associated with executing statements of the SQL query batch.

6. The method of claim 1, wherein the plurality of statistics includes one or more operation quantity metrics associated with executing statements of the SQL query batch.

7. The method of claim 1, wherein the plurality of statistics includes statistics associated with one or more application programming interfaces (APIs) called when executing statements of the SQL query batch.

8. The method of claim 7, wherein the plurality of statistics further includes statistics associated with stored procedures (SPROCs) that are called by each API of the one or more APIs when executing statements of the SQL query batch.

9. The method of claim 1, further comprising associating one or more application programming interfaces (APIs) with one or more stored procedures (SPROCs) called by the APIs when executing statements of the SQL query batch.

10. The method of claim 9, wherein the trigger condition comprises a threshold metric with respect to statistics from the plurality of statistics associated with an SPROC called by an API of the one or more APIs.

11. The method of claim 10, wherein the mitigation action comprises throttling requests associated with the API based on the statistics associated with the SPROC exceeding the threshold metric.

12. The method of claim 1, wherein performing the mitigation action comprises throttling requests received from clients associated with the trigger condition.

13. A system, comprising:
one or more processors;
memory in electronic communication with the one or more processors; and
instructions stored in the memory, the instructions being executable by the one or more processors to:
initiate a batch request including an in-line request of an SQL query batch that includes multiple SQL statements, the batch request including identifiers of different statistics for an SQL server to collect in conjunction with execution of the SQL query batch on the SQL server;
receive a result set associated with the SQL query batch, the result set including a plurality of statistics from the different statistics identified within the batch request, the plurality of statistics being associated with statements of the SQL query batch that are received in conjunction with execution of the SQL query batch based on the batch request being an in-line request;
detect, from the result set, a trigger condition associated with executing the SQL query batch, the trigger condition indicating a threshold metric observed in the plurality of statistics contained within the result set; and
perform a mitigation action with respect to one or more subsequently received SQL statements based on the detected trigger condition from the result set for the SQL query batch.

14. The system of claim 13, wherein the result set includes:
an information message received from the SQL server in conjunction with a query response based on the batch request being an in-line request.

15. The system of claim 13, wherein the plurality of statistics includes one or more of:
at least one resource usage metrics associated with executing statements of the SQL query batch;
at least one latency metrics associated with executing statements of the SQL query batch; or
at least one quantity metrics associated with executing statements of the SQL query batch.

16. The system of claim 13, wherein the plurality of statistics includes statistics associated with one or more application programming interfaces (APIs) called when executing the statements of the SQL query batch.

17. The system of claim 13, further comprising instructions being executable by the one or more processors to associate one or more application programming interfaces (APIs) with one or more stored procedures (SPROCs) called by the APIs when executing statements of the SQL query batch.

18. (canceled)

19. A non-transitory computer-readable medium storing instructions thereon that, when executed by at least one processor, causes one or more computing devices to:
initiate a batch request including an in-line request of an SQL query batch that includes multiple SQL statements, the batch request including identifiers of different statistics for an SQL server to collect in conjunction with execution of the SQL query batch on the SQL server;
receive a result set associated with the SQL query batch, the result set including a plurality of statistics from the different statistics identified within the batch request, the plurality of statistics being associated with statements of the SQL query batch that are received in conjunction with execution of the SQL query batch based on the batch request being an in-line request;
detect, from the result set, a trigger condition associated with executing the SQL query batch, the trigger condition indicating a threshold metric observed in the plurality of statistics contained within the result set; and
perform a mitigation action with respect to one or more subsequently received SQL statements based on the detected trigger condition from the result set for the SQL query batch.

20. (canceled)

21. The method of claim 1, wherein the result set includes a result table including the plurality of statistics associated with the statements of the SQL query batch.

22. The method of clam 1, wherein the result set includes at least one batch-level statistic indicating a cumulative statistic for the multiple SQL statements.

23. The method of claim 22, wherein the result set includes a combination of the at least one batch-level statistic indicating the cumulative statistic and one or more statement statistics including indicating individual statistics for the multiple SQL statements.
